(19) United States
(12) Patent Application Publication
(10) Pub. No.: US 2022/0001925 A1
(43) Pub. Date: Jan. 6, 2022

(54) SUBFRAME STRUCTURE

(71) Applicant: HONDA MOTOR CO., LTD., Tokyo (JP)

(72) Inventor: Satoru NOGUCHI, Wako-shi, Saitama (JP)

(21) Appl. No.: 17/279,255

(22) PCT Filed: Sep. 27, 2018
(86) PCT No.: PCT/JP2018/036156

§ 371 Date: Mar. 24, 2021

(51) Int. Cl. B62D 21/02

(52) U.S. Cl. CPC B62D 21/02

(57) ABSTRACT

A subframe structure includes: a pair of right and left vehicle body side frames disposed at side portions of a vehicle body; a vehicle body cross-member extending in a vehicle width direction between the vehicle body side frames; and a pair of right and left longitudinal members extending along the vehicle body side frames. Each longitudinal member includes: a first bent portion disposed in a middle of the longitudinal member at which the longitudinal member extending in the longitudinal direction is bent toward outside in the vehicle width direction; a front end portion extending outward in the vehicle width direction from the first bent portion toward the vehicle body side frame; a first attachment portion provided in proximity to the first bent portion and attached to the vehicle body cross-member; and a second attachment portion provided on the front end portion and attached to the vehicle body side frame.

### TECHNICAL FIELD

The present invention relates to a subframe structure mounted on a vehicle such as an automobile.

### BACKGROUND ART

For example, Patent Literature 1 discloses a structure in which a suspension bolt is disposed such that the central axis of the suspension bolt is in proximity to a corresponding right or left rear side member having a rigidity higher than that of a rear cross-member. In other words, the offset amount from the central axis of the suspension bolt to the rear cross-member and the rear side member is decreased.

According to Patent Literature 1, this structure can enhance the rigidity for supporting the suspension bolt.

### CITATION LIST

### Patent Literature

Patent Literature 1: Japanese Patent No. 2893611

### SUMMARY OF THE INVENTION

### Technical Problem

According to the rear structure disclosed in Patent Literature 1, a member to which a collision load generated in a rear-end collision is input is constituted only by a pair of right and left rear side members. To satisfy recent crash safety standards, it is necessary to increase the cross-section of each of the rear side members or to add another reinforcement member, which disadvantageously leads to an increase in the overall weight of the vehicle and manufacturing cost.

This is particularly problematic, especially, when a drive source such as a drive motor is disposed in a rear portion of the vehicle body.

In view of the above, an object of the present invention is to provide a subframe structure capable of improving the rigidity and strength of the rear side of the vehicle body while suppressing an increase in the overall weight of the vehicle and manufacturing cost.

### Solution to Problem

To solve the above problem, the present invention provides a subframe structure comprising: a pair of right and left vehicle body side frames disposed at side portions of a vehicle body and extending in a longitudinal direction of a vehicle; a vehicle body cross-member extending in a vehicle width direction between the vehicle body side frames; and a pair of right and left longitudinal members extending along the vehicle body side frames at positions centrally spaced apart in the vehicle width direction for a predetermined distance from the vehicle body side frames, wherein each of the longitudinal members comprises: a first bent portion disposed in a middle of the longitudinal member at which the longitudinal member extending in the longitudinal direction is bent toward outside in the vehicle width direction; a front end portion extending outward in the vehicle width direction from the first bent portion toward the vehicle body side frame; a first attachment portion provided in proximity to the first bent portion and attached to the vehicle body cross-member; and a second attachment portion provided on the front end portion and attached to the vehicle body side frame.

Further, the present invention provides a subframe structure comprising: a pair of right and left vehicle body side frames disposed at side portions of a vehicle body and extending in a longitudinal direction of a vehicle; a vehicle body cross-member extending in a vehicle width direction between the vehicle body side frames; a pair of right and left longitudinal members extending along the vehicle body side frames at positions centrally spaced apart in the vehicle width direction for a predetermined distance from the vehicle body side frames; and a subframe cross-member extending in the vehicle width direction between the longitudinal members, wherein each of the vehicle body side frames comprises a side sill and a rear side frame, wherein each of the longitudinal members comprises a second bent portion disposed in a middle of the longitudinal member at which the longitudinal member extending in the longitudinal direction is bent toward outside in the vehicle width direction, and a first bent portion provided longitudinally frontward of the second bent portion and bent further toward outside in the vehicle width direction, wherein the subframe cross-member connects between the second bent portions of the right and left longitudinal members, and wherein the vehicle body cross-member connects between the first bent portions of the right and left longitudinal members.

### Advantageous Effects of the Invention

According to the present invention, there is provided a subframe structure, which can improve the rigidity and strength of the rear side of the vehicle body while suppressing an increase in the overall weight of the vehicle and manufacturing cost.

### BRIEF DESCRIPTION OF THE DRAWINGS

FIG. 1 is a bottom view, as viewed from a bottom side, of a rear side of a vehicle body, in which a rear subframe according to one embodiment of the present invention is assembled.

FIG. 2 is a vertical sectional view taken along the line II-II of FIG. 1.

FIG. 3 is a perspective cross-sectional view taken along the line II-II of FIG. 1.

FIG. 4 is a vertical cross-sectional view taken along the line IV-IV of FIG. 1.

FIG. 5 is a partially sectional perspective view in the direction of arrow Y in FIG. 1.

FIG. 6 is a plan view of the rear subframe shown in FIG. 1.

FIG. 7 is an enlarged perspective view of a front portion of the rear subframe shown in FIG. 6.

FIG. 8 is an enlarged vertical section taken along the line VIII-VIII of FIG. 6.

### DESCRIPTION OF EMBODIMENTS

Next, one embodiment of the present invention is described in detail with reference to the accompanying drawing where appropriate.

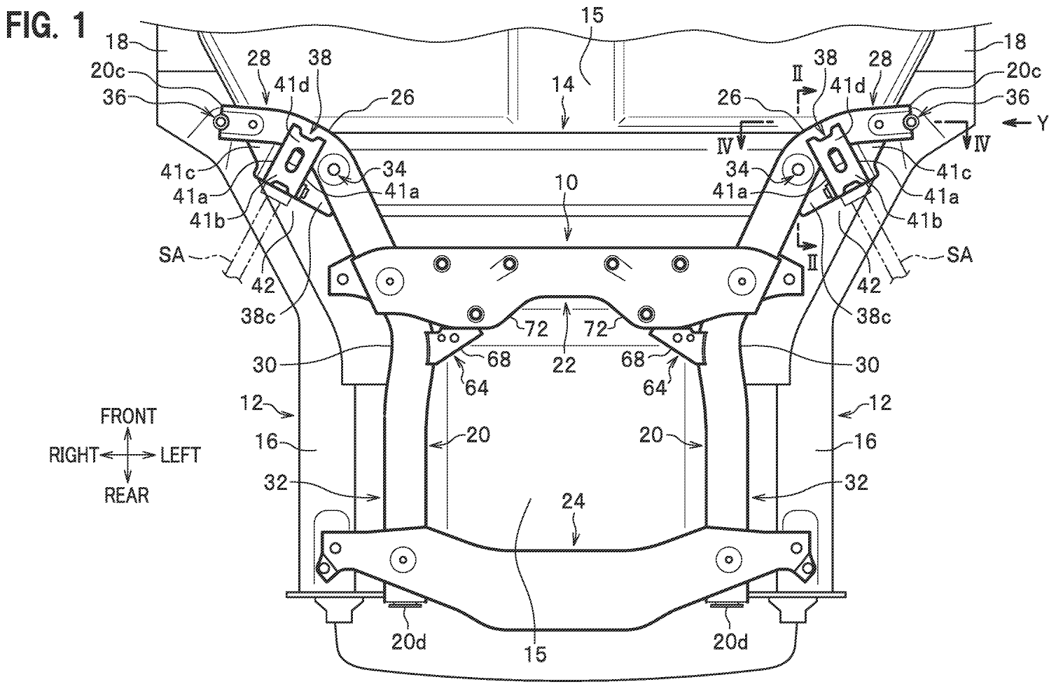

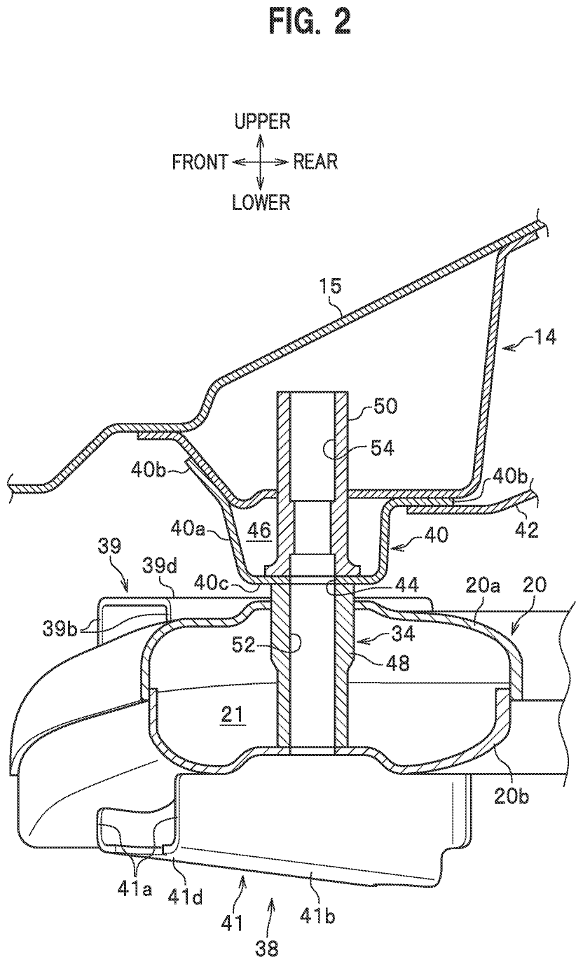

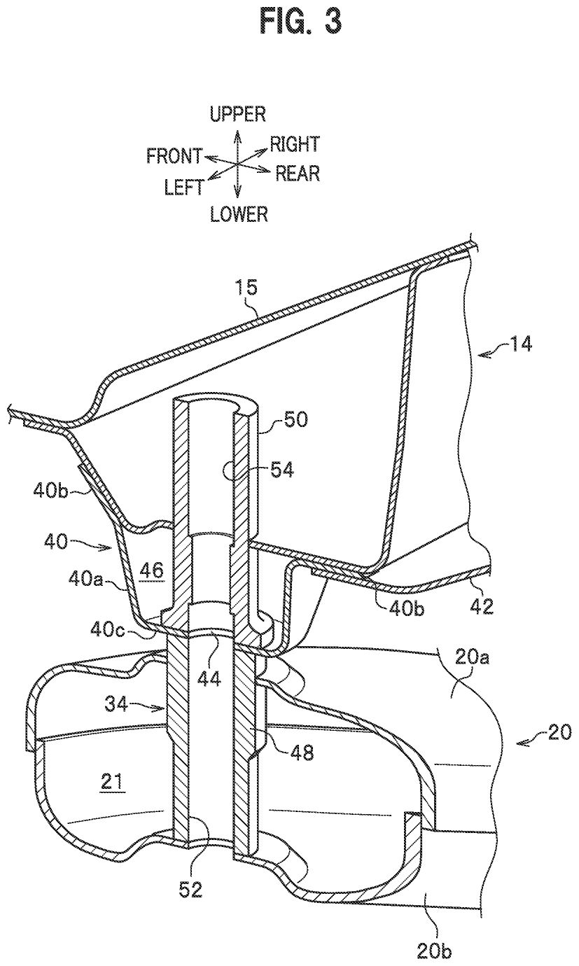

FIG. 1 is a bottom view, as viewed from a bottom side, of a rear side of a vehicle body, in which a rear subframe according to one embodiment of the present invention is assembled, FIG. 2 is a vertical sectional view taken along the line II-II of FIG. 1, and FIG. 3 is a perspective cross-sectional view taken along the line II-II of FIG. 1. In the drawings, front and rear directions refer to corresponding directions in the longitudinal direction (i.e., front-rear direction) of a vehicle, right and left directions refer to corresponding directions in the vehicle width direction (i.e., lateral direction or right-left direction) of the vehicle, and upper and lower directions refer to corresponding directions in the vertical direction (i.e., upper-lower direction) of the vehicle.

As seen in FIG. 1, a rear subframe (subframe) 10 according to one embodiment of the present invention, a pair of right and left vehicle body side frames 12, 12 disposed at side portions of a vehicle body and extending in the longitudinal direction of a vehicle, and a vehicle body cross-member 14 extending in the vehicle width direction between the pair of right and left vehicle body side frames 12, 12 are disposed in a rear side of the vehicle body. A rear floor panel 15 having a generally flat shape is mounted between the pair of right and left vehicle body side frames 12, 12 in the vehicle width direction.

The vehicle body side frames 12, 12 include a pair of right and left rear side frames 16, 16, and a pair of right and left side sills 18, 18. These rear side frames 16, 16 and side sills 18, 18 are connected in the longitudinal direction of the vehicle at the right and left side portions of the vehicle body.

The rear subframe 10 is located laterally inward of the pair of right and left vehicle body side frames 12, 12 and mounted on the lower side of the pair of right and left vehicle body side frames 12, 12. Further, the rear subframe 10 is configured to support rear suspension systems (not shown) and also to support a power unit (not shown) such as a drive source (e.g., motor and engine) through vibration isolators (not shown).

As seen in FIG. 1, the rear subframe 10 includes the pair of right and left longitudinal members 20, 20 extending in the longitudinal direction (front-rear direction) of the vehicle, and a cross-member extending in the vehicle width direction between the pair of right and left longitudinal members 20, 20. The cross-member includes a front cross-member (subframe cross-member) 22 fixed to the longitudinally front side of the pair of right and left longitudinal members 20, 20, and a rear cross-member 24 fixed to the longitudinally rear side of the pair of right and left longitudinal members 20, 20.

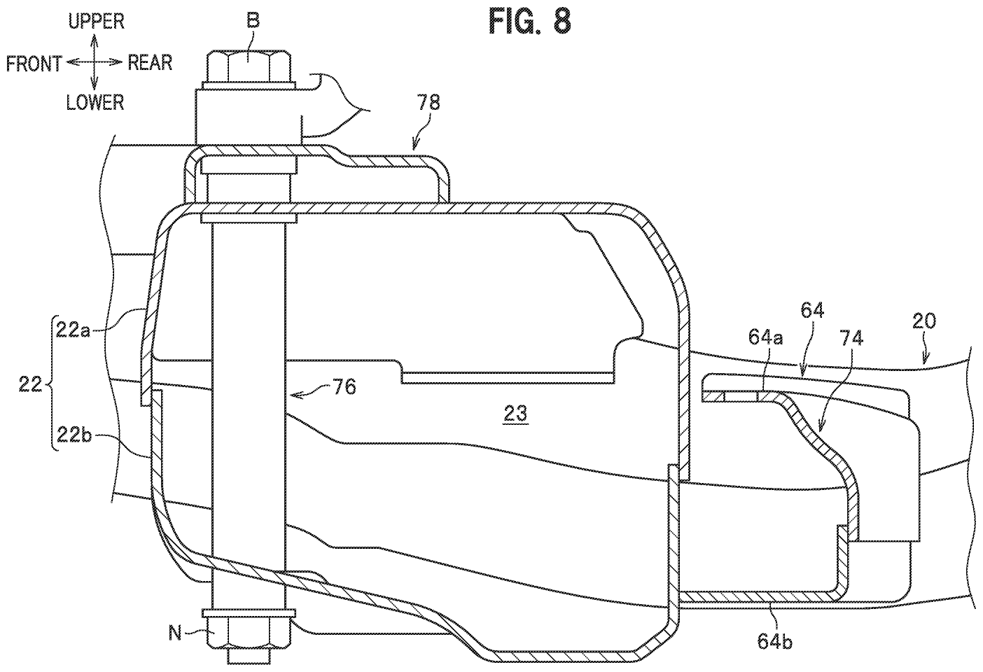

As seen in FIG. 8 (to be described later on), the front cross-member 22 includes an upper wall 22a whose section perpendicular to the axis thereof is generally U-shape, and a lower wall 22b whose section perpendicular to the axis thereof is generally U-shape; right and left lower end portions of the upper wall 22a and right and left upper end portions of the lower wall 22b are joined integrally. A closed section 23 is formed between the upper wall 22a and the lower wall 22b.

Similar to the front cross-member 22, the rear cross-member 24 includes an upper wall whose section perpendicular to the axis thereof is generally U-shape, and a lower wall whose section perpendicular to the axis thereof is generally U-shape, so that a closed section portion (not shown) having a closed section is formed by the upper wall and the lower wall.

The pair of right and left longitudinal members 20, 20 are similar in construction and arranged in a laterally symmetrical manner. As seen in FIGS. 2 and 3, each of the longitudinal members 20, 20 includes an upper wall portion 20a having a U-shaped section, and a lower wall portion 20b having a U-shaped section. The upper wall portion 20a and the lower wall portion 20b are integrally connected (joined) through flange portions to form a closed section 21 inside the longitudinal member 20. Further, as seen in FIG. 1, longitudinally front end portions 20c, 20c of the longitudinal members 20, 20 are located further outside in the vehicle width direction than longitudinally rear end portions 20d, 20d of the longitudinal members 20, 20, so that the longitudinal members 20, 20 are arranged in a forwardly divergent configuration.

As seen in FIG. 1, the pair of right and left longitudinal members 20, 20 extend along the pair of right and left vehicle body side frames 12, 12 at positions centrally spaced apart in the vehicle width direction for a predetermined distance from the vehicle body side frames 12, 12. Each of the longitudinal members 20, 20 includes a first bent portion 26, a front end portion 28, a second bent portion 30, and a straight portion 32.

The first bent portion 26 is disposed in a middle of a longitudinally front side of the longitudinal member 20 extending in the longitudinal direction and is bent from outside in the vehicle width direction toward the vehicle body side frame 12. The front end portion 28 extends outward in the vehicle width direction toward the vehicle body side frame 12 from the first bent portion 26 to the longitudinally front end portion 20c. The second bent portion 30 is located longitudinally rearward of the first bent portion 26 and is bent in a middle of the longitudinal member 20 extending in the longitudinal direction toward the first bent portion 26. The straight portion 32 is located longitudinally rearward of the second bent portion 30 and extends substantially linearly along the longitudinal direction of the vehicle from the second bent portion 30 to the longitudinally rear end portion 20d.

Further, each of the longitudinal members 20, 20 includes a first attachment portion 34 and a second attachment portion 36.

As seen in FIG. 1, the first attachment portion 34 is provided in proximity to and longitudinally rearward of the first bent portion 26 to attach the longitudinal member 20 to the vehicle body cross-member 14. The second attachment portion 36 is provided on the front end portion 28 to attach the longitudinal member 20 to the vehicle body side frame 12.

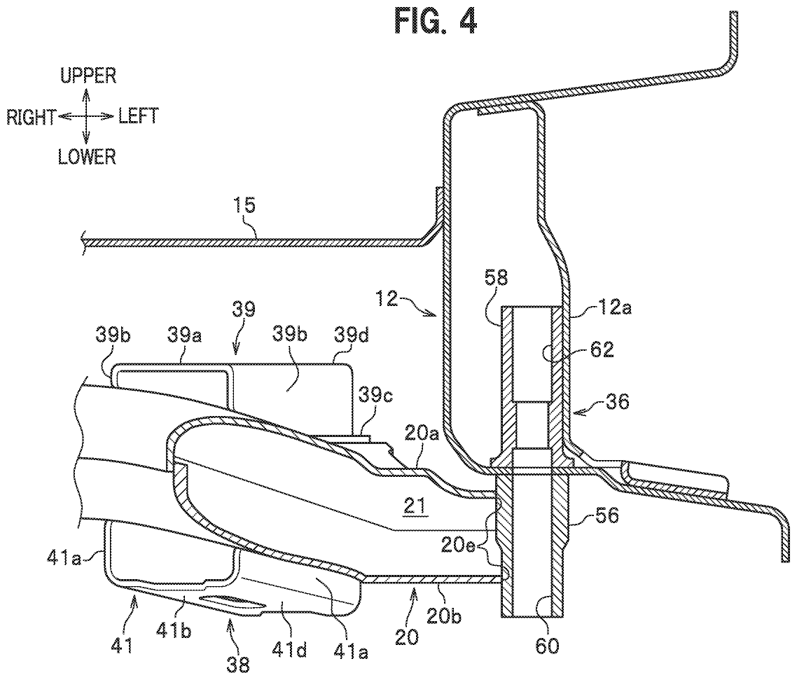

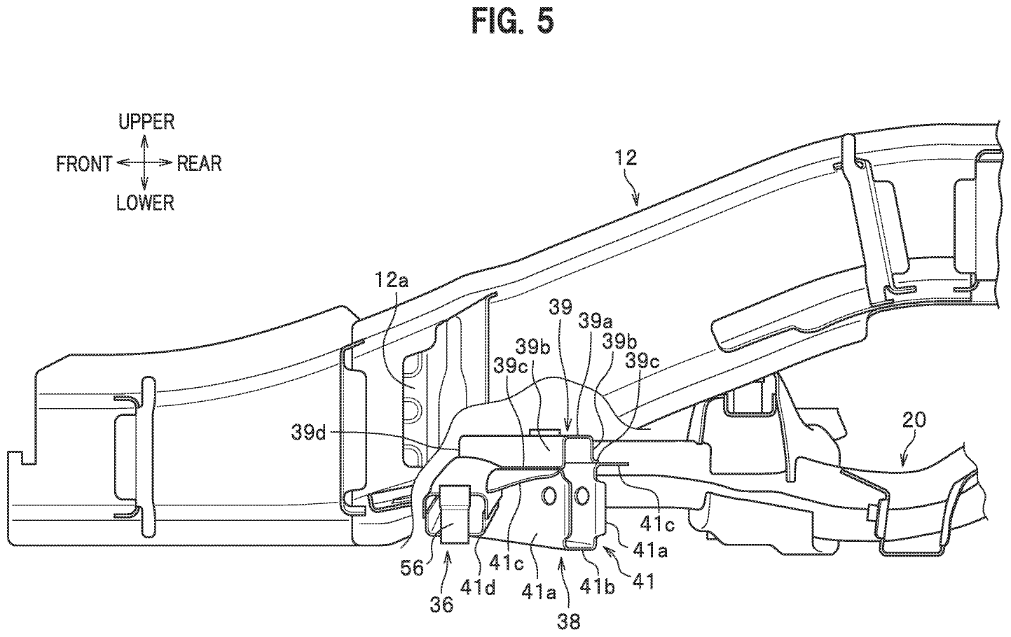

FIG. 4 is a vertical cross-sectional view taken along the line IV-IV of FIG. 1, and FIG. 5 is a partially sectional perspective view in the direction of arrow Y in FIG. 1.

A first bracket 38 is disposed between the first attachment portion 34 and the second attachment portion 36. The first bracket 38 serves as a suspension arm attachment portion, to which a suspension arm SA for a rear suspension system (not shown) is rotatably attached using a bushing (not shown). As seen in FIGS. 5 and 4, the first bracket 38 includes an upper bracket 39 and a lower bracket 41 that are divided vertically and joined together to enhance the rigidity and strength of the first bracket 38.

The upper bracket 39 includes an upper wall portion 39a, a pair of right and left side wall portions 39b, 39b continuous from the upper wall portion 39a and disposed opposite to each other, and a pair of joint flange portions 39c, 39c continuous from lower ends of the right and left side wall portions 39b, 39b. The upper bracket 39 includes an upper holding portion 39d provided by cutting a part of a longitudinally front side of the upper bracket 39.

The lower bracket 41 includes a pair of right and left side wall portions 41a, 41a disposed substantially parallel to and opposite to each other, a bottom wall portion 41b connecting lower portions of the side wall portions 41a, 41a, and a pair of joint flange portions 41c, 41c continuous from upper portions of the side wall portions 41a, 41a. The lower bracket 41 includes a lower curved holding portion 41d provided by cutting a part of a longitudinally front side of the lower bracket 41 into a curved shape.

The upper bracket 39 and the lower bracket 41 are integrally connected (joined) by joining the joint flange portions 39c, 39c of the upper bracket 39 and inner portions of the joint flange portions 41c, 41c of the lower bracket 41 together in the vertical direction. When the upper bracket 39 and the lower bracket 41 are joined together, the upper holding portion 39d and the lower curved holding portion 41d that are located one on top of another in the vertical direction holds the longitudinal member 20 between the upper bracket 39 and the lower bracket 41.

As seen in FIGS. 2 and 3, a second bracket 40 is disposed under the vehicle body cross-member 14. The second bracket 40 includes side wall portions 40a, fixed flange portions 40b continuous from upper ends of the side wall portions 40a and fixed (joined) to the vehicle body cross-member 14, and a bottom wall portion 40c continuous from lower ends of the side wall portions 40a and having an insertion hole 44, through which a second collar member 50 (to be described later on) is inserted.

The second bracket 40 is attached to a lower surface portion of the vehicle body cross-member 14 to form a closed section 46 with the vehicle body cross-member 14. The first attachment portion 34 of each of the longitudinal members 20, 20 is attached to the vehicle body side frame 12 through the second bracket 40.

Provided in the first attachment portion 34 is a first collar member 48 having a generally cylindrical shape and vertically connecting the interior of the closed section 21 of the longitudinal member 20. Also provided in the first attachment portion 34 is a second collar member 50 having a generally cylindrical shape and vertically connecting the interior of the closed section 46 of the second bracket 40. The first collar member 48 and the second collar member 50 are arranged such that they are substantially coaxially and vertically superposed one on top of another in the upper-lower direction.

Further, the first collar member 48 has a first through hole 52 extending through the first collar member 48 along its axis. The second collar member 50 has a second through hole 54 extending through the second collar member 50 along its axis. The first through hole 52 and the second through hole 54 are in communication with each other. The vehicle body cross-member 14, the second bracket 40 and the longitudinal member 20 are tightened together at the first attachment portion 34 using a fastening bolt (not shown) inserted through the first through opening 52 and the second through opening 54 and a nut (not shown).

As seen in FIG. 4, a lower collar member 56 vertically extending through the closed section 21 of the longitudinal member 20 is disposed in the second attachment portion 36. A side peripheral portion of the lower collar member 56 is joined to a curved portion 20e provided in the longitudinally front end portion 20c of the longitudinal member 20. Further, the second attachment portion 36 is provided with an upper collar member 58 that is joined to a lower vertical wall 12a of the vehicle body side frame 12. The lower collar member 56 and the upper collar member 58 are arranged such that they are coaxially and vertically superposed one on top of another in the upper-lower direction. The longitudinal member 20 is attached to the vehicle body side frame 12 at the second attachment portion 36 using a fastening bolt (not shown) inserted through the through opening 60 of the lower collar member 56 and the through opening 62 of the upper collar member 58 and a nut (not shown).

The vehicle body cross-member 14 connects the first bent portions 26, 26 provided in the pair of right and left longitudinal members 20, 20. The front cross-member 22 of the rear subframe 10 connects the second bent portions 30, 30 provided in the pair of right and left longitudinal members 20, 20. In other words, the vehicle body cross-member 14 extending in the vehicle width direction connects the first bent portions 26, 26 of the pair of right and left longitudinal members 20, 20, and the front cross-member 22 extending in the vehicle width direction connects the second bent portions 30, 30 of the pair of right and left longitudinal members 20, 20.

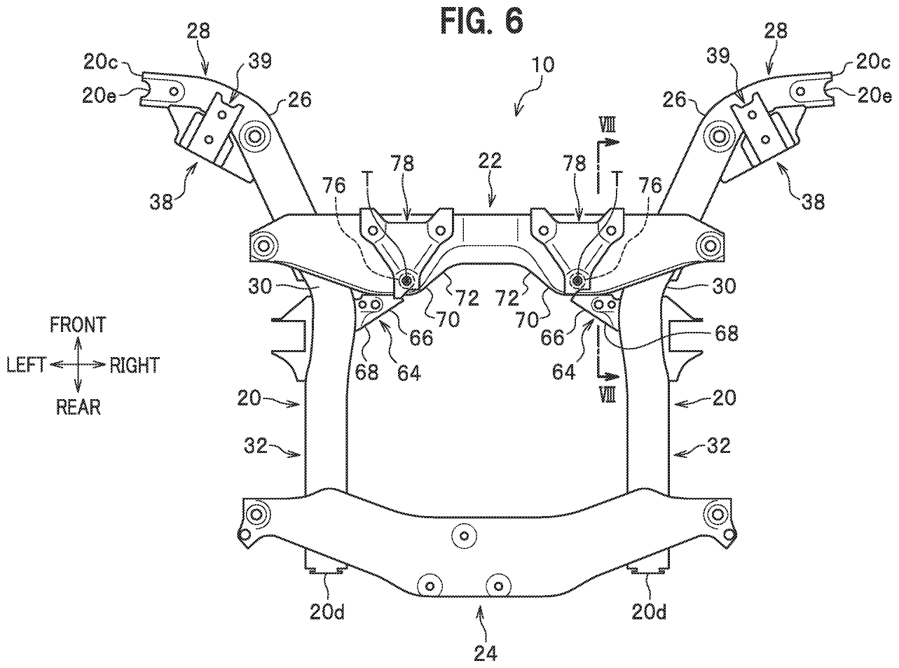

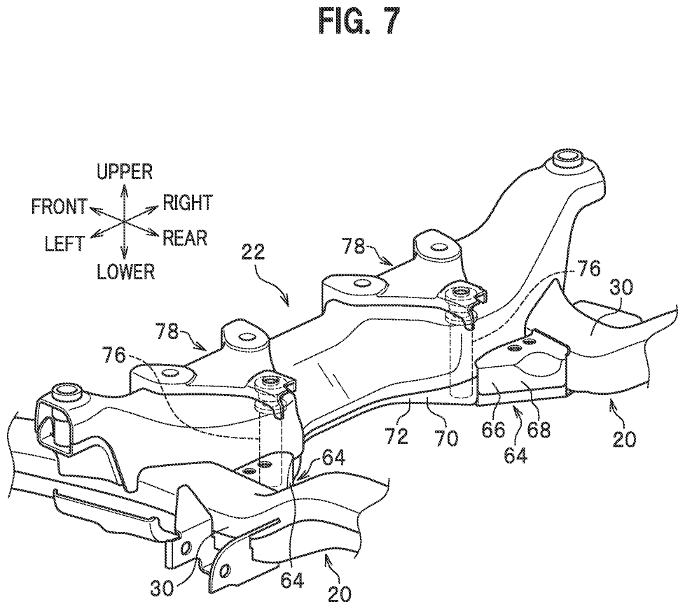

FIG. 6 is a plan view of the rear subframe shown in FIG. 1, FIG. 7 is an enlarged perspective view of the front portion of the rear subframe shown in FIG. 6, and FIG. 8 is an enlarged vertical section taken along the line VIII-VIII of FIG. 6.

As seen in FIG. 6, a pair of right and left gussets 64, 64 are provided at joint portions between the pair of right and left longitudinal members 20, 20 and the front cross-member 22. Each of the gussets 64, 64 includes a first oblique surface portion 68 having a first oblique surface 66 extending obliquely between each of the longitudinal members 20, 20 and the front cross-member 22.

The front cross-member 22 of the rear subframe 10 includes second oblique surface portions 72 each having a second oblique surface 70. The first oblique surface 66 of the first oblique surface portion 68 of each of the gussets 64, 64 and the second oblique surface 70 of the second oblique surface portion 72 of the front cross-member 22 form a continuous surface.

As seen in FIG. 8, each of the gussets 64, 64 includes an upper gusset 64a having a generally L-shaped section, and a lower gusset 64b having a generally L-shaped section. Each of the gussets 64, 64 has a U-shaped section portion 74 having a U-shaped section that is formed by the upper gusset 64a and the lower gusset 64b.

As seen in FIG. 8, provided in the front cross-member 22 is a third collar member 76 vertically connecting the interior of the closed section 23 of the front cross-member 22. The third collar member 76 is disposed in the closed section 23 of the front cross-member 22 between the first oblique surface portion 68 and the second oblique surface portion 72.

Each of the vibration isolators (not shown) includes a mount portion 78 (see FIG. 6) constituted by a plurality of leg portions. The vibration isolators are fixed to the front cross-member 22 and the rear cross-member 24 using bolts B and nuts N that are fastened at the mount portions 78 (see FIG. 8). A mounting point T at which the mount portion 78 is attached to the front cross-member 22 is disposed in a position vertically superposed on the third collar member 76 (see FIG. 6).

The vibration isolators are substantially the same in construction. Each vibration isolator is configured as an active-type vibration isolator and provides a positive or compensating vibration effect on a vibration target, from which vibration is to be isolated by generating vibration on the vibration isolator with a drive unit (not shown).

The rear subframe 10 according to this embodiment is basically configured as described above, and operational effects thereof are described below.

According to this embodiment, the longitudinal members 20, 20 are arranged to extend along the vehicle body side frames 12, 12 at positions centrally spaced apart in the vehicle width direction for a predetermined distance from the vehicle body side frames 12, 12. Further, according to this embodiment, each of the longitudinal members 20, 20 includes the first bent portion 26, the front end portion 28, the first attachment portion 34, and the second attachment portion 36.

According to this configuration in this embodiment, since the vehicle body side frames 12, 12 and the longitudinal members 20, 20 are arranged substantially parallel to each other with a predetermined distance spaced apart therebetween, a load to be inputted in a rear-end collision can be distributed and transmitted to the vehicle body side frames 12, 12 and the longitudinal members 20, 20. Further, according to this embodiment, load transmitted to the first bent portion 26 and the front end portion 28 that are disposed in the longitudinally front side of each longitudinal member 20 can be transmitted respectively to the vehicle body side frame 12 and the vehicle body cross-member 14 through the first attachment portion 34 and the second attachment portion 36. As a result, according to this embodiment, it is possible to improve the rigidity and strength of the rear side of the vehicle body while suppressing an increase in the overall weight of the vehicle and manufacturing cost.

Further, according to this embodiment, the first bracket 38 is disposed between the first attachment portion 34 having high rigidity and strength and the second attachment portion 36. This makes it possible in this embodiment to enhance the supporting rigidity if the first bracket 38 supports a component such as a suspension arm SA as well as to improve the rigidity and strength of the first attachment portion 34 disposed in proximity to the first bent portion 26 by the use of the first bracket 38.

Further, according to this embodiment, the subframe structure includes the second bracket 40 attached to the vehicle body cross-member 14 to form the closed section 46 with the vehicle body cross-member 14, and the first attachment portion 34 is attached to the vehicle body side frame 12 through the second bracket 40. According to this configuration in this embodiment, it is possible to improve the supporting rigidity for supporting the rear subframe 10 with respect to the vehicle body.

Further, according to this embodiment, the first attachment portion 34 has the first collar member 48 vertically connecting the interior of the closed section 21 of the longitudinal member 20, and the second collar member 50 vertically connecting the interior of the closed section 46 of the second bracket 40. According to this embodiment, providing the first collar member 48 and the second collar member 50 makes it possible to suppress deformation at the closed section 21 of the longitudinal member 20 and the closed section 46 of the second bracket 40 in the vertical direction (upper-lower direction). As a result, it is possible to further improve the supporting rigidity for supporting the rear subframe 10 with respect to the vehicle body. Further, since the first collar member 48 and the second collar member 50 can receive a shear load generated between the vehicle body and the rear subframe 10, it is possible to prevent the rear subframe 10 from coming off in a rear-end collision and to improve the load transmission efficiency.

Further, according to this embodiment, each of the longitudinal members 20, 20 has the second bent portion 30 provided longitudinally rearward of the first bent portion 26 and bent toward the first bent portion 26. Further, according to this embodiment, the vehicle body cross-member 14 connects the first bent portions 26, 26 of the right and left longitudinal members 20, 20, and the front cross-member 22 connects the second bent portions 30, 30 of the right and left longitudinal members 20, 20.

According to this embodiment, providing the second bent portions 30, 30 makes it possible to increase the distance in the vehicle width direction between the right and left longitudinal members 20, 20, so that the layout space for a drive source (e.g., motor) and a power transmission mechanism (e.g., transmission and differential gear assembly) can be ensured. Further, since the first bent portions 26, 26 and the second bent portions 30, 30 of the longitudinal members 20, 20 are respectively connected by the vehicle body cross-member 14 and the front cross-member 22, it is possible to suppress a decrease in the rigidity and strength of the rear subframe 10 due to the first bent portions 26, 26 and the second bent portions 30, 30.

Further, according to this embodiment, the pair of right and left gussets 64, 64 are provided at joint portions between the pair of right and left longitudinal members 20, 20 and the front cross-member 22. Each of the gussets 64, 64 includes the first oblique surface portion 68 having the first oblique surface 66 extending obliquely between each of the longitudinal members 20, 20 and the front cross-member 22. According to this configuration in this embodiment, it is possible to improve the rigidity and strength of the vehicle body by reinforcing the second bent portion 30 of each longitudinal member 20 using the gusset 64.

Further, according to this embodiment, each of the gussets 64, 64 includes the first oblique surface portion 68 extending obliquely between each of the longitudinal members 20, 20 and the front cross-member 22, and the front cross-member 22 includes the second oblique surface portion 72 that forms a continuous surface with the first oblique surface portion 68 of the gusset 64. According to this configuration in this embodiment, since the first oblique surface portion 68 of the gusset 64 and the second oblique surface portion 72 of the front cross-member 22 form a continuous surface, the load transmission efficiency from the gusset 64 to the front cross-member 22 can be enhanced. As a result, according to this embodiment, the rigidity and strength of the joint portions can be improved while suppressing a stress concentration at the joint portions between the longitudinal members 20, 20 and the front cross-member 22.

Further, according to this embodiment, each of the gussets 64, 64 includes the U-shaped section portion 74 having a U-shaped section along the vertical direction (upper-lower direction). This configuration in this embodiment can improve the rigidity and strength of the gusset 64 per se and thus the load transmission efficiency can be further improved.

Further, according to this embodiment, each of the gussets 64, 64 includes the upper gusset 64a having a generally L-shaped section and the lower gusset 64b having a generally L-shaped section, and the U-shaped section portion 74 is formed by the upper gusset 64a and the lower gusset 64b. According to this configuration in this embodiment, since the gusset 64 is divided into the upper gusset 64a and the lower gusset 64b, the degree of freedom of the shape of the gusset 64 is increased and the cross-sectional height of the U-shaped section portion 74 can be increased. As a result, according to this embodiment, it is possible to improve the formability of the gusset 64 and the rigidity and strength of the gusset 64 in a balanced manner.

Further, according to this embodiment, the subframe structure includes the third collar member 76 vertically connecting the interior of the closed section 23 of the front cross-member 22, and the third collar member 76 is disposed between the second oblique surface portion 72 of the front cross-member 22 and the first oblique surface portion 68 of the gusset 64 (see FIG. 7).

According to this embodiment, a portion where a stress is relatively likely to concentrate in the load transmission path, that is, between the second oblique surface portion 72 of the front cross-member 22 and the first oblique surface portion 68 of the gusset 64, can be reinforced by the third collar member 76 having high rigidity and strength. According to this configuration in this embodiment, the load transmission efficiency can be further improved and the rigidity and strength of the rear subframe 10 can be further improved.

Furthermore, according to this embodiment, the subframe structure includes the mount portion 78 attached to the front cross-member 22, and the mounting point T at which the mount portion 78 is attached to the front cross-member 22 is disposed in a position vertically superposed on the axis of the third collar member 76 (see FIG. 6). According to this embodiment, a portion where a stress is relatively likely to concentrate in the load transmission path, that is, between the second oblique surface portion 72 of the front cross-member 22 and the first oblique surface portion 68 of the gusset 64, can be reinforced by the mounting point T of the mount portion 78. According to this configuration in this embodiment, the load transmission efficiency can be further improved and the rigidity and strength of the rear subframe 10 can be further improved.

Furthermore, according to this embodiment, each of the longitudinal members 20, 20 includes the second bent portion 30 disposed in a middle of the longitudinal member 20 at which the longitudinal member 20 extending in the longitudinal direction is bent toward outside in the vehicle width direction, and the first bent portion 26 provided longitudinally frontward of the second bent portion 30 and bent further toward outside in the vehicle width direction. The front cross-member 22 connects between the second bent portions 30, 30 of the pair of right and left longitudinal members 20, 20. The vehicle body cross-member 14 connects between the first bent portions 26, 26 of the pair of right and left longitudinal members 20, 20. According to this embodiment, providing the second bent portions 30, 30 makes it possible to increase the distance in the vehicle width direction between the right and left longitudinal members 20, 20, so that the layout space for a drive source (e.g., motor) and a power transmission mechanism (e.g., transmission and differential gear assembly) can be ensured. Further, according to this embodiment, providing the first bent portions 26, 26 makes it possible to extend the front end portion 28 of each of the longitudinal members 20, 20 in proximity to the vehicle body side frame 12 (the side sill 18 and the rear side frame 16), so that the load transmission efficiency between the longitudinal member 20, the side sill 18, and the rear side frame 16 can be enhanced. Further, since the first bent portions 26, 26 and the second bent portions 30, 30 of the longitudinal members 20, 20 are respectively connected by the vehicle body cross-member 14 and the front member 22, it is possible to suppress a decrease in the rigidity and strength of the rear subframe 10 due to the first bent portions 26, 26 and the second bent portions 30, 30.

### DESCRIPTION OF REFERENCE NUMERALS

10 rear subframe (subframe)
12 vehicle body side frame
14 vehicle body cross-member
16 rear side frame
18 side sill
20 longitudinal member
21 closed section (of longitudinal member)
22 front cross-member (subframe cross-member)
23 closed section (of front cross-member)
26 first bent portion
28 front end portion
30 second bent portion
34 first attachment portion
36 second attachment portion
38 first bracket
40 second bracket
46 closed section (of second bracket)
48 first collar member
50 second collar member
64 gusset
64a upper gusset
64b lower gusset
66 first oblique surface
68 first oblique surface portion
70 second oblique surface
72 second oblique surface portion
74 U-shaped section portion
76 third collar member
78 mount portion
T mounting point

1. A subframe structure comprising:
a pair of right and left vehicle body side frames disposed at side portions of a vehicle body and extending in a longitudinal direction of a vehicle;
a vehicle body cross-member extending in a vehicle width direction between the vehicle body side frames; and
a pair of right and left longitudinal members extending along the vehicle body side frames at positions centrally spaced apart in the vehicle width direction for a predetermined distance from the vehicle body side frames,
wherein each of the longitudinal members comprises:
a first bent portion disposed in a middle of the longitudinal member at which the longitudinal member extending in the longitudinal direction is bent toward outside in the vehicle width direction;
a front end portion extending outward in the vehicle width direction from the first bent portion toward the vehicle body side frame;
a first attachment portion provided in proximity to the first bent portion and attached to the vehicle body cross-member; and
a second attachment portion provided on the front end portion and attached to the vehicle body side frame.

2. The subframe structure according to claim 1, wherein a first bracket is disposed between the first attachment portion and the second attachment portion.

3. The subframe structure according to claim 1, further comprising a second bracket attached to the vehicle body cross-member to form a closed section with the vehicle body cross-member,
wherein the first attachment portion of each of the longitudinal members is attached to the vehicle body side frame through the second bracket.

4. The subframe structure according to claim 3, wherein the first attachment portion has a first collar member vertically connecting an interior of the closed section of the longitudinal member, and a second collar member provided in a position vertically superposed on the first collar member and vertically connecting an interior of the closed section of the second bracket.

5. The subframe structure according to claim 1, further comprising a subframe cross-member extending in the vehicle width direction between the longitudinal members,
wherein each of the longitudinal members has a second bent portion provided longitudinally rearward of the first bent portion and bent in a middle of the longitudinal member toward the first bent portion,
wherein the vehicle body cross-member connects the first bent portions provided in the right and left longitudinal members, and
wherein the subframe cross-member connects the second bent portions provided in the right and left longitudinal members.

6. The subframe structure according to claim 5, further comprising a pair of right and left gussets provided at joint portions between the longitudinal members and the subframe cross-member, and
wherein each of the gussets includes a first oblique surface portion having a first oblique surface extending obliquely between each of the longitudinal members and the subframe cross-member.

7. The subframe structure according to claim 6, wherein the subframe cross-member includes second oblique surface portions each having a second oblique surface, and
wherein the first oblique surface of each of the first oblique surface portions and the second oblique surface of each of the second oblique surface portions form a continuous surface.

8. The subframe structure according to claim 6, wherein each of the gussets includes a U-shaped section portion having a U-shaped section.

9. The subframe structure according to claim 7, wherein each of the gussets includes an upper gusset having a generally L-shaped section, and a lower gusset having a generally L-shaped section, and
wherein the U-shaped section portion is formed by the upper gusset and the lower gusset.

10. The subframe structure according to claim 6, further comprising a third collar member vertically connecting an interior of a closed section of the subframe cross-member,
wherein the third collar member is disposed in the closed section of the subframe cross-member between the first oblique surface portion and the second oblique surface portion.

11. The subframe structure according to claim 6, further comprising a mount portion attached to the subframe cross-member,
wherein a mounting point at which the mount portion is attached to the subframe cross-member is disposed in a position vertically superposed on the third collar member.

12. A subframe structure comprising:
a pair of right and left vehicle body side frames disposed at side portions of a vehicle body and extending in a longitudinal direction of a vehicle;
a vehicle body cross-member extending in a vehicle width direction between the vehicle body side frames;
a pair of right and left longitudinal members extending along the vehicle body side frames at positions centrally spaced apart in the vehicle width direction for a predetermined distance from the vehicle body side frames; and
a subframe cross-member extending in the vehicle width direction between the longitudinal members,
wherein each of the vehicle body side frames comprises a side sill and a rear side frame,
wherein each of the longitudinal members comprises a second bent portion disposed in a middle of the longitudinal member at which the longitudinal member extending in the longitudinal direction is bent toward outside in the vehicle width direction, and a first bent portion provided longitudinally frontward of the second bent portion and bent further toward outside in the vehicle width direction,
wherein the subframe cross-member connects between the second bent portions of the right and left longitudinal members, and
wherein the vehicle body cross-member connects between the first bent portions of the right and left longitudinal members.
